(19) United States
(12) Patent Application Publication
(10) Pub. No.: US 2016/0078558 A1
(43) Pub. Date: Mar. 17, 2016

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Hiroyuki UEDA, Kanagawa (JP)

(21) Appl. No.: 14/617,138

(22) Filed: Feb. 9, 2015

(30) Foreign Application Priority Data
Sep. 17, 2014 (JP) 2014-188525

(51) Int. Cl. G06Q 40/00

(52) U.S. Cl. CPC G06Q 40/12

(57) ABSTRACT

An information processing apparatus includes a change unit. The change unit changes, in a case where a defect of a certain control is detected during an audit of a first organization, an audit method for a second organization that has a control equivalent to the certain control.

### CROSS-REFERENCE TO RELATED APPLICATIONS

This application is based on and claims priority under 35 USC 119 from Japanese Patent Application No. 2014-188525 filed Sep. 17, 2014.

### BACKGROUND

### Technical Field

The present invention relates to an information processing apparatus, an information processing method, and a non-transitory computer readable medium.

### SUMMARY

According to an aspect of the invention, there is provided an information processing apparatus including a change unit. The change unit changes, in a case where a defect of a certain control is detected during an audit of a first organization, an audit method for a second organization that has a control equivalent to the certain control.

### BRIEF DESCRIPTION OF THE DRAWINGS

An exemplary embodiment of the present invention will be described in detail based on the following figures, wherein:

FIG. 1 is a conceptual module configuration diagram illustrating an example conformation according to the exemplary embodiment;

FIG. 2 is an explanatory diagram illustrating an example system configuration for implementing the exemplary embodiment;

FIG. 3 is an explanatory diagram illustrating an example system configuration for implementing the exemplary embodiment;

FIG. 4 is a flowchart illustrating an example of processing according to the exemplary embodiment;

FIGS. 5A and 5B include a flowchart illustrating an example of processing according to the exemplary embodiment;

FIG. 6 is an explanatory diagram illustrating an example of the data structure of an audit method management table;

FIG. 7 is an explanatory diagram illustrating an example of the data structure of a change rule management table;

FIG. 8 is an explanatory diagram illustrating an example of the data structure of a number-of-samples management table;

FIG. 9 is an explanatory diagram illustrating an example of processing according to the exemplary embodiment;

FIG. 10 is an explanatory diagram illustrating an example of the data structure of a control/impact correspondence table;

FIG. 11 is an explanatory diagram illustrating an example of processing according to the exemplary embodiment;

FIG. 12 is an explanatory diagram illustrating an example of processing according to the exemplary embodiment;

FIG. 13 is an explanatory diagram illustrating an example of processing according to the exemplary embodiment;

FIG. 14 is an explanatory diagram illustrating an example of processing according to the exemplary embodiment;

FIG. 15 is an explanatory diagram illustrating an example of processing according to the exemplary embodiment; and

FIG. 16 is a block diagram illustrating an example of the hardware configuration of a computer that implements the exemplary embodiment.

### DETAILED DESCRIPTION

Hereinafter, an exemplary embodiment of the present invention will be described with reference to the attached drawings.

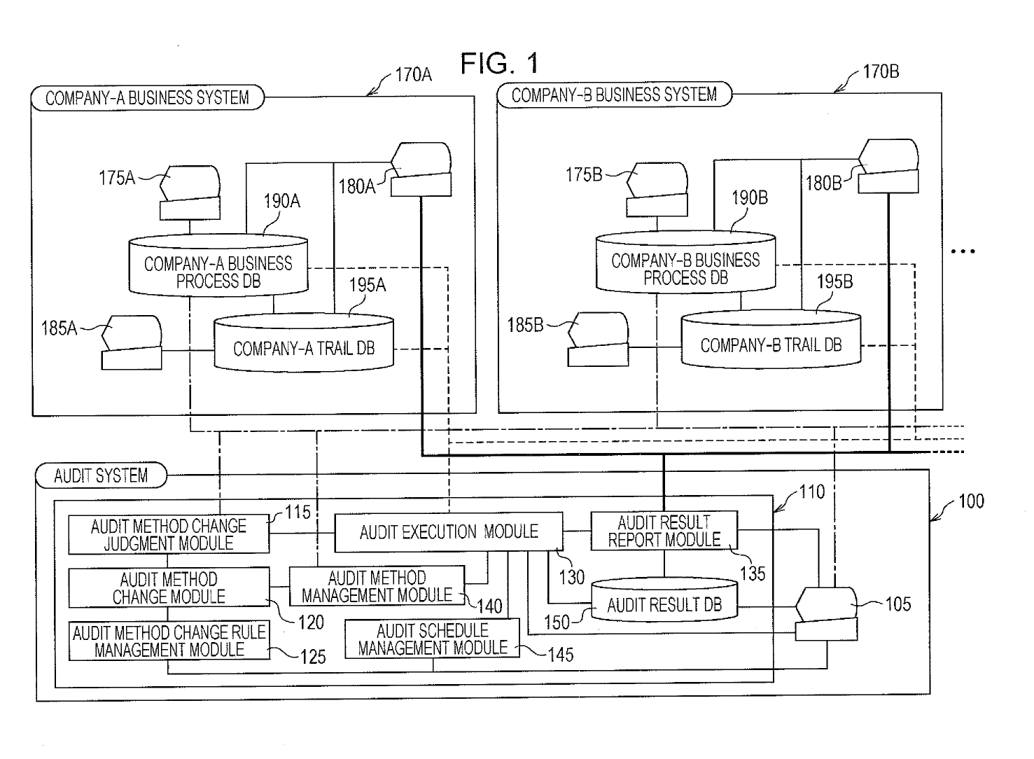

FIG. 1 is a conceptual module configuration diagram illustrating an example configuration according to the exemplary embodiment.

Modules are components of software (computer programs) or hardware that may be logically separated from one another in general. Thus, the modules according to the exemplary embodiment correspond to not only modules in a computer program but also modules in a hardware configuration. Therefore, the description of the exemplary embodiment includes a description of a computer program for causing a computer to function as those modules (a program for causing a computer to execute individual program steps, a program for causing a computer to function as individual units, or a program for causing a computer to implement individual functions), a system, and a method. For the convenience of description, expressions “store” and “cause . . . to store”, and expressions equivalent thereto will be used. These expressions specifically mean “cause a storage device to store” or “perform control to cause a storage device to store” in the case of a computer program. The modules may correspond to functions in a one-to-one relationship. In terms of packaging, a single module may be constituted by a single program, plural modules may be constituted by a single program, or a single module may be constituted by plural programs. Also, plural modules may be executed by a single computer, or a single module may be executed by plural computers in a distributed or parallel environment. Alternatively, a single module may include another module. Hereinafter, “connection” is used to refer to a logical connection (transmission and reception of data, an instruction, a reference relationship between pieces of data, etc.) as well as a physical connection. “Predetermined” means being determined before target processing, and includes the meaning of being determined in accordance with a present situation/state or in accordance with a previous situation/state before target processing after processing according to the exemplary embodiment starts, as well as before processing according to the exemplary embodiment starts. In a case where there are plural predetermined values, the plural predetermined values may be different from one another, or two or more of the values (of course including all the values) may be the same. A description having the meaning “in the case of A, B is performed” is used as the meaning “whether A or not is determined, and B is performed if it is determined A”, except for a case where determination of whether A or not is unnecessary.

A system or apparatus may be constituted by plural computers, hardware units, devices, or the like connected to one another via a communication medium, such as a network (including communication connections having a one-to-one correspondence), or may be constituted by a single computer, hardware unit, device, or the like. “Apparatus” and “system” are used synonymously. Of course, “system” does not include a man-made social “organization” (social system).

Target information is read from a storage device in individual processing operations performed by respective modules or in individual processing operations performed by a single module. After each processing operation has been performed, a processing result is written into the storage device. Thus, a description of reading from the storage device before a processing operation and writing into the storage device after a processing operation may be omitted. Here, examples of the storage device include a hard disk, a random access memory (RAM), an external storage medium, a storage device connected through a communication line, a register in a central processing unit (CPU), and the like.

In the exemplary embodiment, controls suitable for managing risks that may arise in an organization are assigned according to an assessment that is defined by International Organization for Standardization (ISO), specifically ISO 27001 or the like, Information Security. Management System (ISMS), or the like.

In order to execute internal controls, it is necessary to create a risk control matrix (RCM) or the like as a basic document. The RCM is a table of assertions of controls to be achieved, possible risks, and corresponding internal control activities about internal control activities related to a business process in an organization. An assertion is a precondition of defining that financial information is reliable information. Specifically, six items of reality, completeness, assessment, rights and duties, period/distribution, and display are used in general. However, the items vary according to a company or auditor, and thus may be customized. A risk is a factor of inhibiting achievement of a target of an organization, specifically, an obstruction for an assertion assumed in a business process. A control is an internal control activity for reducing a risk, and includes a preventive control and a heuristic control. An organization is a target to which internal controls are applied, for example, a corporation, a company, a division, or the like. Hereinafter, a company is used as an example of an organization. Sampling (the number of samples) is a term that is used for assessing a control (an operation test, hereinafter simply referred to as a test), and is a procedure of assessing an overall characteristic on the basis of a result obtained from verification of some items. A population is an entire group from which a test target of sampling is to be extracted at random. A trail is a trace that serves as evidence.

An audit system 100 according to the exemplary embodiment executes an audit as internal control, and includes an audit system manager terminal 105 and an information processing apparatus 110, as illustrated in FIG. 1. The information processing apparatus 110 includes an audit method change judgment module 115, an audit method change module 120, an audit method change rule management module 125, an audit execution module 130, an audit result report module 135, an audit method management module 140, an audit schedule management module 145, and an audit result database (DB) 150.

The audit system 100 is used from a company-A business system 170A and a company-B business system 170B, which are connected to the audit system 100 via a communication line. The audit system 100 executes, for example, a service of changing an audit method for an organization when a defect is detected. More specifically, in a case where a defect of a certain control is detected during an audit of a certain organization, the audit system 100 changes an audit method for another organization that has a control equivalent to the certain control.

A description will be given of an example in which company A, company B, and so forth are target organizations. Other than companies, any organizations that serve as audit targets may be target organizations, for example, divisions in a company. Company A and company B may be group companies, franchisees, affiliated companies, or the like, or may be independent organizations that are not related to each other.

It is necessary to reinforce an audit in order to determine, when a defect in a control occurs during an audit of a certain company, whether or not a similar defect has occurred in another company. In an audit service for auditing plural companies, the audit system 100 audits the control status of a certain company, judges whether or not to change an audit method for another company if a defect is detected in the audit, and changes the audit method for the other company in accordance with the judgment result.

The company-A business system 170A includes a company-A business process manager terminal 175A, a company-A control supervisor terminal 180A, a company-A trail registrar terminal 185A, a company-A business process DB 190A, and a company-A trail DB 195A. The company-B business system 170B includes a company-B business process manager terminal 175B, a company-B control supervisor terminal 180B, a company-B trail registrar terminal 185B, a company-B business process DB 190B, and a company-B trail DB 195B. The company-A business system 170A and the company-B business system 170B have system configurations equivalent to each other. The system configurations do not need to be identical to each other, and it is sufficient that both the systems have functions equivalent to each other in the relationship with the audit system 100.

The business process DB 190 is connected to the business process manager terminal 175, the control supervisor terminal 180, the trail DB 195, and the audit system manager terminal 105, and is also connected to the audit method change judgment module 115, the audit execution module 130, and the audit method management module 140 of the information processing apparatus 110. The business process DB 190 stores information about a process of executing business, a risk involved in the process, and a control for preventing the actualization of the risk. Also, the business process DB 190 may store information about an executor and approver of the process, and information about an executor and approver of the control.

The business process manager terminal 175 is connected to the business process DB 190. The business process manager terminal 175 is used by a business process manager who has rights to register, edit, and delete the data stored in the business process DB 190 to perform an operation of registering, editing, or deleting the data.

The trail DB 195 is connected to the control supervisor terminal 180, the trail registrar terminal 185, the business process DB 190, and the audit execution module 130 of the information processing apparatus 110. The trail DB 195 stores trails of execution of controls.

The trail registrar terminal 185 is connected to the trail DB 195. The trail registrar terminal 185 is used by a trail registrar who has a right to register a trail in the trail DB 195 to perform a registration operation.

The control supervisor terminal 180 is connected to the business process DB 190, the trail DB 195, and the audit result report module 135 of the information processing apparatus 110. The control supervisor terminal 180 is a terminal used by a control supervisor of a business process. The control supervisor terminal 180 displays the information stored in the business process DB 190 and the trail DB 195, so that a control status may be checked. Also, the control supervisor terminal 180 is capable of displaying a report transmitted from the audit system 100 (described below).

The audit schedule management module 145 is connected to the audit system manager terminal 105 and the audit execution module 130. The audit schedule management module 145 stores audit schedules for individual organizations, and has a function of causing the audit execution module 130 (described below) to execute audits in accordance with the audit schedules.

According to a schedule of an ordinary audit, registration, edit, deletion, and so forth are executed via the audit system manager terminal 105 (described below) in accordance with an operation performed by an audit system manager.

Under this function, one audit schedule is expressed by the following one set of attributes.
A schedule ID is data for uniquely identifying an audit schedule in the audit system 100.
A target organization is data representing an organization as an audit target.
A date and time of start is data representing a date and time when an audit is started.
A date and time of end is data representing a date and time when an audit is ended.
An execution state represents an execution state of an audit, and is a value representing any one of “has not started”, “being executed”, and “has been executed”.
A type of audit represents a type of audit, and is a value representing either of “ordinary” and “extraordinary”.
A target control is data representing a target control to be audited. In the exemplary embodiment, a target control has a single value (that is, one control is audited in accordance with one audit schedule).
An alternative control is set in a case where the type of audit is “extraordinary”, and is data representing the control for changing a target control. In the exemplary embodiment, an alternative control has a single value (that is, one control is audited in accordance with one audit schedule).
An audit method is data representing an audit method for a control. An audit method ID managed by the audit method management module 140 (described below) is set as an attribute value.

The audit method management module 140 is connected to the audit method change module 120, the audit execution module 130, the company-A business process DB 190A of the company-A business system 170A, and the company-B business process DB 190B of the company-B business system 170B. The audit method management module 140 has a function of managing how to execute an audit on a control by using a trail. An audit method may be registered, edited, or deleted via the audit system manager terminal 105 (described below). In a case where an audit method needs to be changed due to a defect that has occurred in an organization, the audit method is changed by the audit method change module 120 (described below). In a case where an audit method has been changed by the audit method change module 120, the audit method before change and the audit method after change are stored for the control. Also, an applicable period of the audit method after change is stored.

The audit execution module 130 is connected to the audit system manager terminal 105, the audit method change judgment module 115, the audit result report module 135, the audit method management module 140, the audit schedule management module 145, the audit result DB 150, the company-A business process DB 190A and the company-A trail DB 195A of the company-A business system 170A, and the company-B business process DB 190B and the company-B trail DB 195B of the company-B business system 170B. The audit execution module 130 executes audits of individual organizations by using business process information and trail information about the individual organizations and the audit method stored in the audit method management module 140 in accordance with one of audit schedules stored in the audit schedule management module 145. Results of the audits are stored in the audit result DB 150 (described below). The audit execution module 130 executes an audit by applying an audit method to the target control that exists in the business process of the target organization.

Also, the audit execution module 130 detects, from information transmitted from the company-A business system 170A, that a defect has occurred in a control during an audit of company A. In a case where a defect of a control is detected, the audit execution module 130 causes the audit method change judgment module 115 (described below) to judge the company and control as a target for which the audit method is to be changed.

The audit method change judgment module 115 is connected to the audit method change module 120, the audit execution module 130, the company-A business process DB 190A of the company-A business system 170A, and the company-B business process DB 190B of the company-B business system 170B. The audit method change judgment module 115 has a function of judging the control of an organization for which the audit method is to be changed when a defect of a control is detected during an audit of a certain organization by the audit execution module 130. Also, the audit method change judgment module 115 has a function of obtaining information about an impact of a detected defect on another organization, and determining whether or not to change the audit method in accordance with the impact. Information about an impact that would be exerted if a defect occurs in a control is obtained from the business process DB 190 of each organization. The impact varies depending on the scale of an organization (the amount of sales or total assets) even if the problem is the same. In a case where the impact is small, an increase in audit cost may be suppressed by not changing the audit method.

In the exemplary embodiment, an impact that would be exerted if a defect occurs in a control is represented by, for example, “large”, “middle”, or “small”, and the audit method is changed in the following case where (1) there is a control similar to a control in which a defect has been detected in a certain company and (2) the impact of the defect in the control is “large” or “middle”. The range (or the lower-limit value) of the impact “large”, the range of the impact “middle” (or the range that is neither “large” nor “small”), and the range (or the upper-limit value) of the impact “small” are predetermined, and the range including the impact is judged to determine the degree of the impact “large”, “middle”, or “small”. Therefore, a case where the impact is “large” or “middle” corresponds to a case where the value of the impact is larger than or equal to the lower-limit value of the range “middle”.

The audit method change module 120 is connected to the audit method change judgment module 115, the audit method change rule management module 125, and the audit method management module 140. In a case where the audit method change judgment module 115 judges that an audit method needs to be changed, the audit method change module 120 obtains a changed audit method from the audit method change rule management module 125 (described below) and changes the audit method for the control managed by the audit method management module 140.

In a case where the audit execution module 130 detects the occurrence of a defect, the audit method change module 120 changes the audit method for company B that has a control equivalent to a control in which the defect has occurred (a control in an audit of company A). The change is executed in accordance with a predetermined rule. Of course, an “equivalent control” includes an identical control and a similar control. For example, as a control for managing a risk of the occurrence of illicit trade, a control A of checking a history of the date of reference and the date of receipt of a trade form and a control B of checking a history of the date and time of reference and the date and time of receipt of a trade form may be regarded as equivalent controls. Whether controls are similar to each other may be judged by using a prepared table in which similar controls are defined.

In a case where the audit execution module 130 detects the occurrence of a defect and in a case where an impact that would affect company B if a defect occurs in a control of company B is larger than or equal to a predetermined threshold, the audit method change module 120 may change the audit method for company B.

Further, the audit method change module 120 may determine a period over which a changed audit method for company B is applicable, cause the audit method management module 140 to store an original audit method before change, and change the changed audit method to the original audit method stored in the audit method management module 140 after the period has elapsed.

The audit method change module 120 may change, as an audit method, any one of reliability, allowable deviation, and the number of samples, or a combination of some or all of the reliability, the allowable deviation, and the number of samples.

The audit method change rule management module 125 is connected to the audit system manager terminal 105 and the audit method change module 120. The audit method change rule management module 125 has a function of managing a condition for judging whether or not to change an audit method and how to change the audit method if it is judged that the audit method needs to be changed. An audit method change rule is registered, edited, or deleted via the audit system manager terminal 105 (described below). In the exemplary embodiment, “adjustment value of reliability”, “adjustment value of allowable deviation”, and “applicable period” are managed with respect to an impact of a defect.

The audit result DB 150 is connected to the audit system manager terminal 105, the audit execution module 130, and the audit result report module 135. The audit result DB 150 has a function of storing results of audits of individual organizations executed by the audit execution module 130. An audit result is stored in association with a schedule ID. When a new audit result is registered, the audit result DB 150 notifies the audit result report module 135 of it.

The audit result report module 135 is connected to the audit system manager terminal 105, the audit execution module 130, the audit result DB 150, the company-A control supervisor terminal 180A of the company-A business system 170A, and the company-B control supervisor terminal 180B of the company-B business system 170B. The audit result report module 135 has a function of reporting an audit result of an organization to the control manager of the organization as an audit target. The audit result report module 135 reports the result in response to a notification from the audit result DB 150.

The audit system manager terminal 105 is connected to the audit method change rule management module 125, the audit execution module 130, the audit result report module 135, the audit schedule management module 145, the audit result DB 150, the company-A business process DB 190A of the company-A business system 170A, and the company-B business process DB 190B of the company-B business system 170B. The audit system manager terminal 105 is a terminal used by a manager of the audit system 100, and has a function of making settings for the above-described functions and checking a processing status.

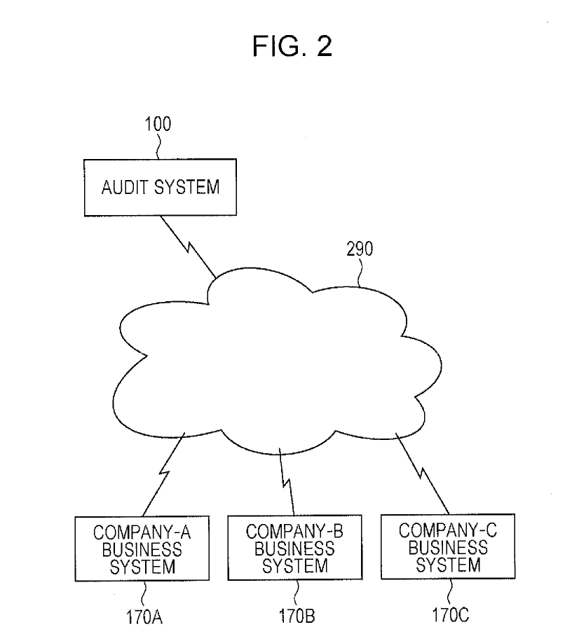

FIG. 2 is an explanatory diagram illustrating an example system configuration for implementing the exemplary embodiment.

The audit system 100, the company-A business system 170A, the company-B business system 170B, and a company-C business system 170C are connected to one another via a communication line 290. The communication line 290 may be a wireless link, a wired link, or a combination thereof, for example, the Internet or the like as a communication infrastructure. In a case where a defect occurs in a control during an audit in the company-A business system 170A, the audit system 100 detects the occurrence, and changes the audit method for the company-B business system 170B and the company-C business system 170C. At this time, the audit system 100 may judge whether or not to change the audit method. Alternatively, the audit system 100 may be implemented as a cloud system.

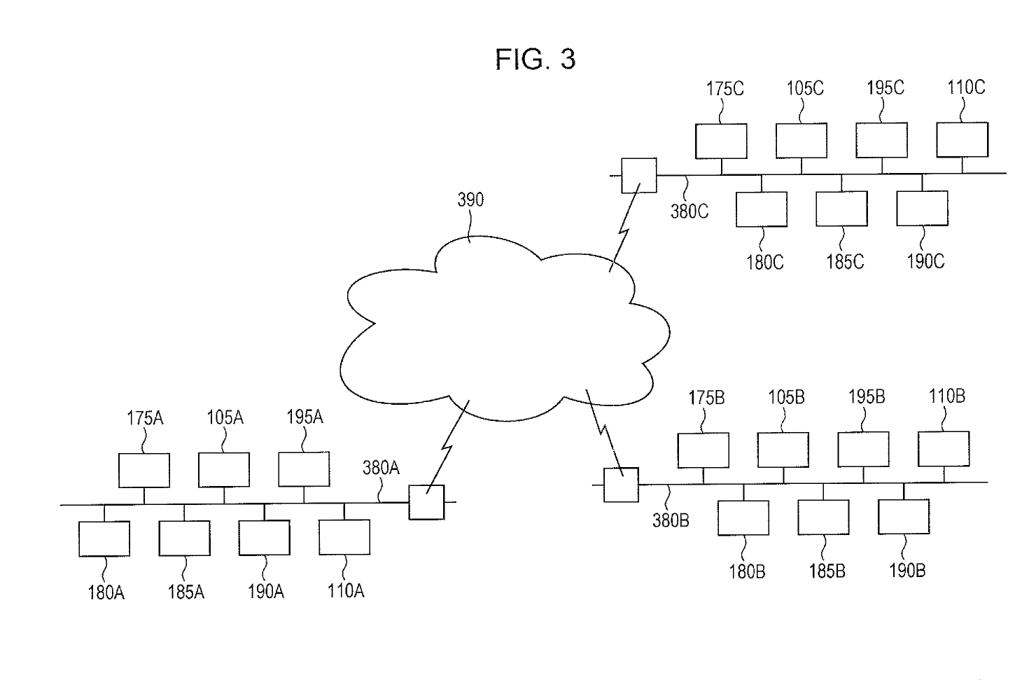

FIG. 3 is an explanatory diagram illustrating an example system configuration for implementing the exemplary embodiment. As in FIG. 2, the audit system 100 may be implemented as a cloud system. In a case where each company has the information processing apparatus 110, the individual information processing apparatuses 110 communicate with one another, and any one of the information processing apparatuses 110 detects the occurrence of a defect of a control during an audit, a judgment instruction to change the audit method may be provided to the other information processing apparatuses 110 (or the audit system manager terminal 105).

In each company, the audit system manager terminal 105, the information processing apparatus 110, the business process manager terminal 175, the control supervisor terminal 180, the trail registrar terminal 185, the business process DB 190, and the trail DB 195 are connected to one another via an in-house communication line 380. The in-house communication line 380 may be a wireless link, a wired link, or a combination thereof, for example, an intranet or the like as a communication infrastructure.

An in-house communication line 380A, an in-house communication line 380B, and an in-house communication line 380C are connected to one another via a communication line 390. The communication line 390 may be a wireless link, a wired link, or a combination thereof, for example, the Internet or the like as a communication infrastructure.

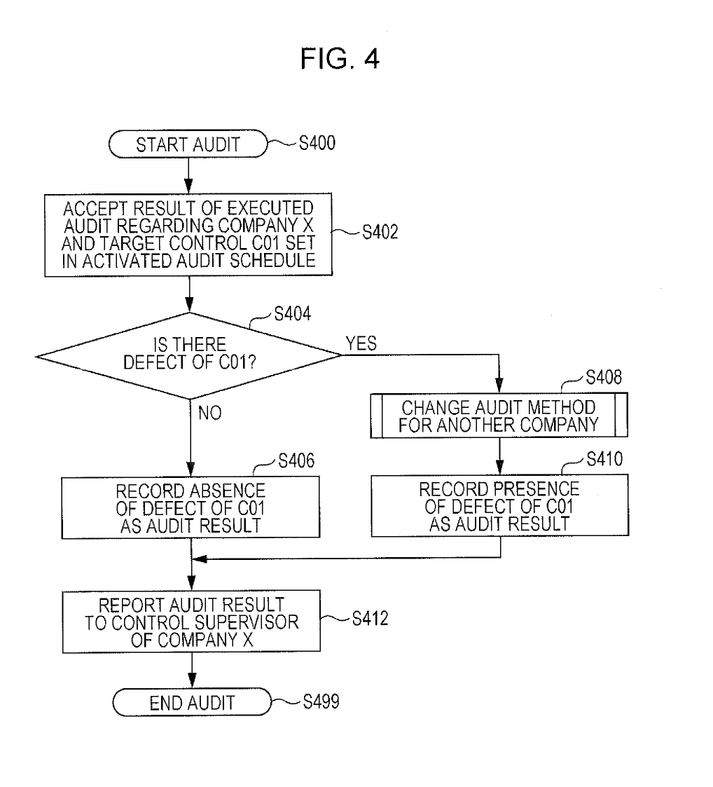

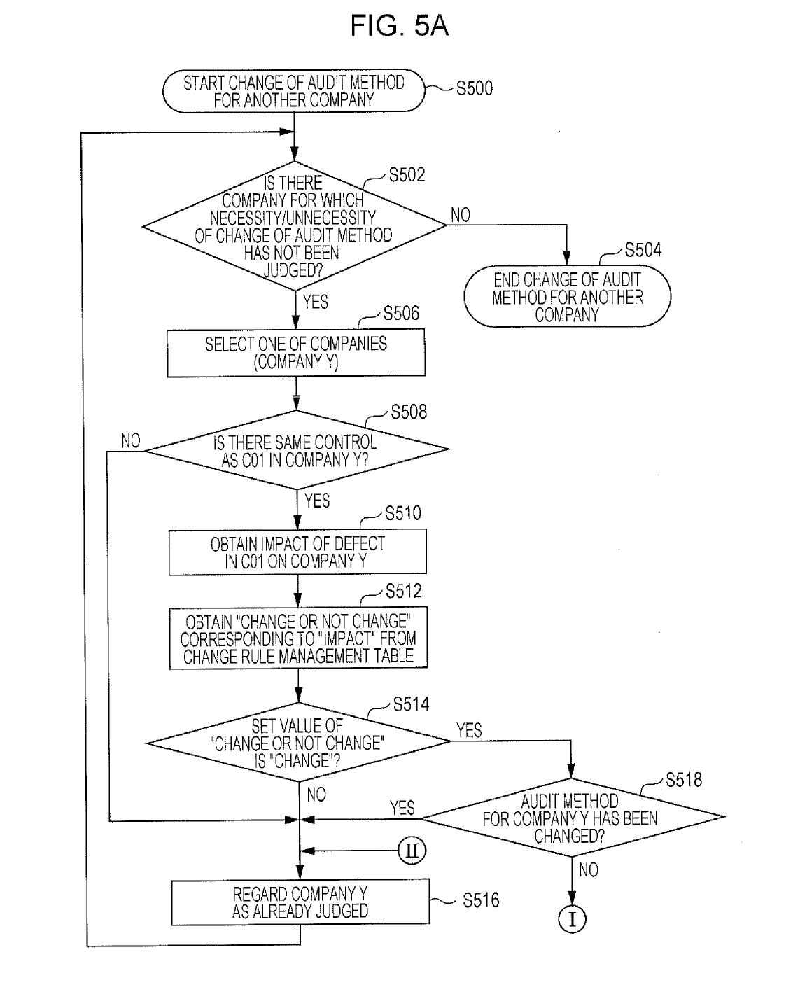

FIG. 4 is a flowchart illustrating an example of processing according to the exemplary embodiment. The flowchart illustrated in FIG. 4 represents the processing that is executed when the date and time to start an audit comes according to a schedule of an ordinary audit. The flowchart illustrated in FIGS. 5A and 5B represents a sub-flow of an extraordinary audit (processing in step S408) included in the flowchart illustrated in FIG. 4.

In step S400, an audit is started.

In step S402, a result of the executed audit is accepted regarding a company (company X) and a target control (control C01) set in an activated audit schedule.

In step S404, it is determined whether or not there is a defect of the control C01. If there is a defect, the processing proceeds to step S408. Otherwise, the processing proceeds to step S406.

In step S406, absence of a defect of the control C01 is recorded as an audit result.

In step S408, the audit method for another company is changed.

In step S410, presence of a defect of the control C01 is recorded as an audit result.

In step S412, the audit result is reported to the control supervisor of company X.

In step S499, the audit ends.

FIGS. 5A and 5B include a flowchart illustrating an example of processing (an example of processing in step S408 in the flowchart illustrated in FIG. 4) according to the exemplary embodiment.

In step S500, change of the audit method for another company is started.

In step S502, it is determined whether or not there is a company for which the necessity/unnecessity of change of the audit method has not been judged. If there is such a company, the processing proceeds to step S506. Otherwise, the processing proceeds to step S504.

In step S504, change of the audit method for another company ends.

In step S506, a company (company Y) is selected from among the companies for which the necessity/unnecessity of change of the audit method has not been judged.

In step S508, it is determined whether or not there is the same control as the control C01 in company Y. If there is the same control, the processing proceeds to step S510. Otherwise, the processing proceeds to step S516.

In step S510, an impact of a defect in the control C01 on company Y is obtained.

In step S512, “change or not change” corresponding to “impact” is obtained from a change rule management table 700.

In step S514, it is determined whether or not the set value of “change or not change” is “change”. If the set value is “change”, the processing proceeds to step S518. Otherwise (“not change”), the processing proceeds to step S516.

In step S516, company Y is regarded as already judged.

In step S518, it is determined whether or not the audit method for company Y has been changed. If the audit method has been changed, the processing proceeds to step S516. Otherwise, the processing proceeds to step S520.

In step S520, “estimated deviation”, “reliability”, and “allowable deviation” for the control C01 of company Y are obtained from an audit method management table 600.

In step S522, “adjustment value of reliability”, “adjustment value of allowable deviation”, and “applicable period” for “impact” are obtained from the change rule management table 700.

In step S524, the number of samples of the control C01 of company Y is obtained from a number-of-samples management table 800 by using “estimated deviation” obtained in step S520 and “reliability” and “allowable deviation” changed by “adjustment value of reliability” and “adjustment value of allowable deviation” obtained in step S522.

In step S526, the values of “reliability”, “allowable deviation”, “number of samples”, and “applicable period” changed or obtained in the preceding steps are set to “reliability (after change)”, “allowable deviation (after change)”, “number of samples (after change)”, and “applicable period (after change)” respectively in the audit method management table 600.

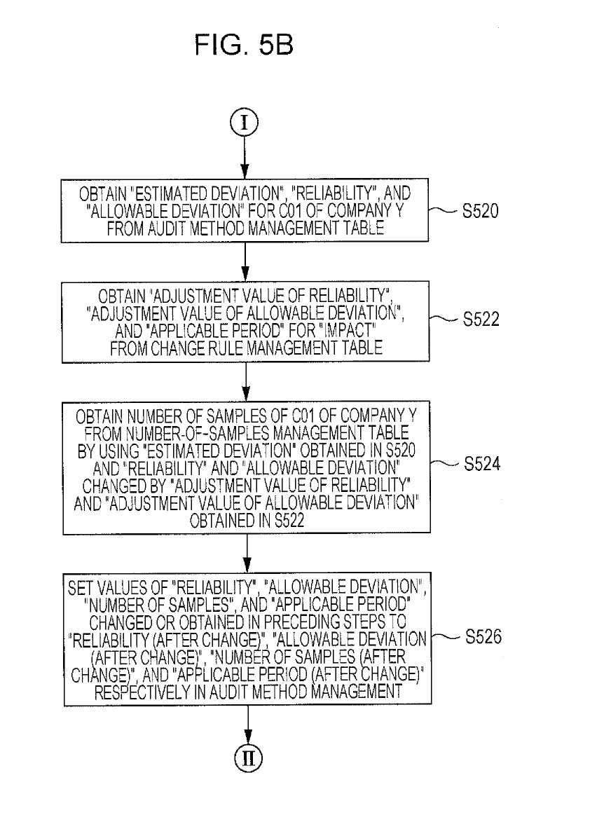

FIG. 6 is an explanatory diagram illustrating an example of the data structure of the audit method management table 600.

The audit method management table 600 includes a “company” column 610, a “control” column 615, an “estimated deviation” column 620, a “reliability” column 625, an “allowable deviation” column 630, a “number of samples” column 635, a “reliability (after change)” column 640, an “allowable deviation (after change)” column 645, a “number of samples (after change)” column 650, and an “applicable period” column 655.

The “company” column 610 stores values representing the companies for which an audit method is to be set. Each of the values is a unique value specifying a company. The value may be, for example, a company identification (ID) or the name of the company.

The “control” column 615 sores values representing the controls for which an audit method is to be set. Each of the values is a unique value specifying a control.

The “estimated deviation” column 620 stores values representing the percentages of deviation of sampling estimated from the maturity of controls. In a case where a control is not sufficiently matured, an estimated deviation is set to be high.

The “reliability” column 625 stores values representing the reliabilities of audits that are statistically obtained through sampling. In an audit of internal control, reliability of 90% or more is normally required.

The “allowable deviation” column 630 stores values representing the percentages of defects allowable in audits. In an audit of internal control, a deviation of less than 9% is normally required.

The “number of samples” column 635 stores values representing the numbers of samples each calculated from the reliability and allowable deviation. In the “number of samples” column 635 in FIG. 6, a value in parentheses represents the number of deviations allowable in the number of samples.

The “reliability (after change)” column 640 stores values representing the reliabilities after the audit method has been changed.

The “allowable deviation (after change)” column 645 stores values representing the allowable deviations after the audit method has been changed.

The “number of samples (after change)” column 650 stores values representing the numbers of samples after the audit method has been changed.

The “applicable period” column 655 stores values representing the applicable periods after the audit method has been changed. Each period may be specified by hours, days, months, years, and so forth, or may be specified by the date and time (year, month, date, hour, minute, second, split-second, or a combination thereof) when the application expires.

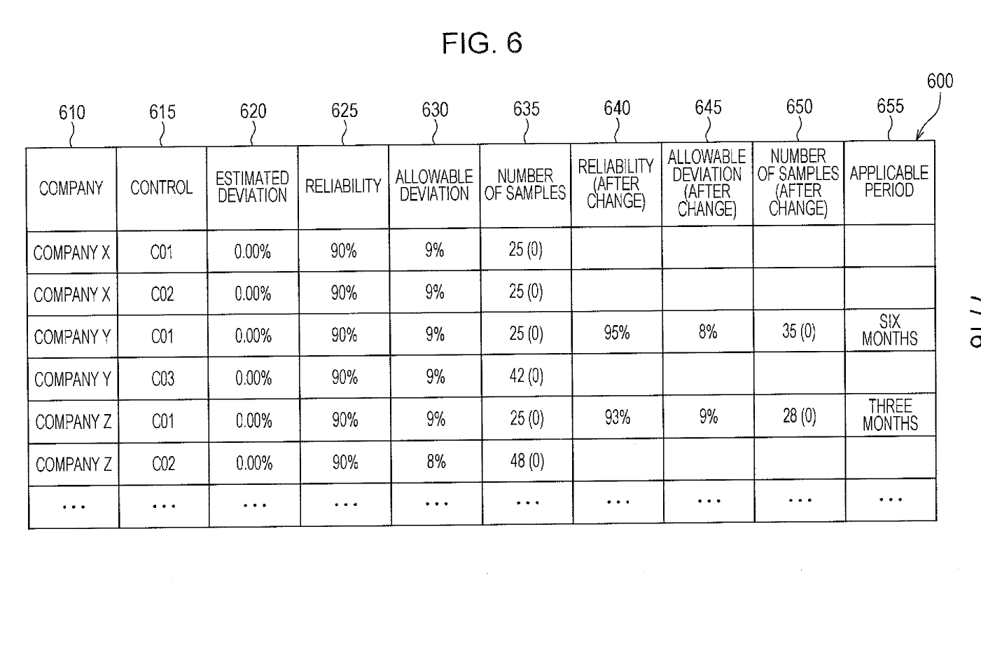

FIG. 7 is an explanatory diagram illustrating an example of the data structure of the change rule management table 700.

The change rule management table 700 includes an “impact of defect” column 710, a “change or not change” column 720, an “adjustment value of reliability” column 730, an “adjustment value of allowable deviation” column 740, and an “applicable period” column 750.

The “impact of defect” column 710 stores values representing impacts of a defect. Each of the values uniquely represents the degree of impact.

The “change or not change” column 720 stores values representing whether or not the audit method is to be changed.

The “adjustment value of reliability” column 730 stores values representing the percentages by which the reliability before change is to be adjusted. Each of the values may be magnification or the like.

The “adjustment value of allowable deviation” column 740 stores values representing the percentages by which the allowable deviation before change is to be adjusted. Each of the values may be magnification or the like.

The “applicable period” column 750 stores values representing the periods over which change is applied. Each of the periods may be specified by hours, days, months, years, and so forth, or may be specified by the date and time when the application expires.

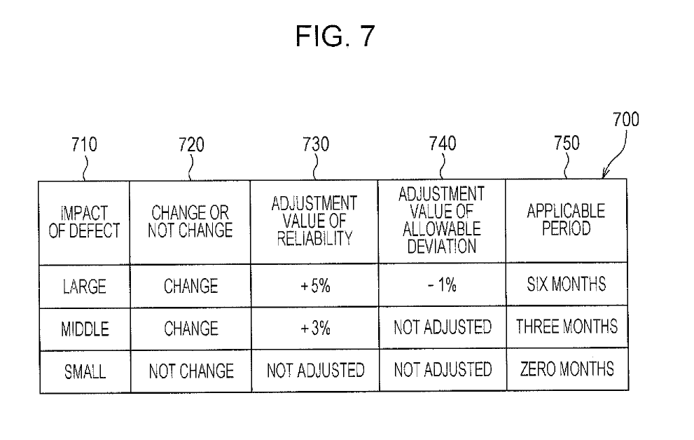

FIG. 8 is an explanatory diagram illustrating an example of the data structure of the number-of-samples management table 800.

The number-of-samples management table 800 includes an “estimated deviation” column 810, a “reliability” column 815, a “number of samples when allowable deviation is less than 2%” column 820, a “number of samples when allowable deviation is less than 3%” column 825, a “number of samples when allowable deviation is less than 4%” column 830, a “number of samples when allowable deviation is less than 5%” column 835, a “number of samples when allowable deviation is less than 6%” column 840, a “number of samples when allowable deviation is less than 7%” column 845, a “number of samples when allowable deviation is less than 8%” column 850, and a “number of samples when allowable deviation is less than 9%” column 855.

The “estimated deviation” column 810 stores values representing the percentages of deviation of sampling estimated from the maturity of controls.

The “reliability” column 815 stores values representing the reliabilities of audits. The number of samples increases as the reliability increases.

The “number of samples when allowable deviation is less than 2%” column 820 to the “number of samples when allowable deviation is less than 9%” column 855 store values representing the numbers of samples corresponding to the percentages of defects allowable in audits. Specifically, the “number of samples when allowable deviation is less than 2%” column 820 stores values representing the numbers of samples when the allowable deviation is less than 2%. The “number of samples when allowable deviation is less than 3%” column 825 stores values representing the numbers of samples when the allowable deviation is less than 3%. The “number of samples when allowable deviation is less than 4%” column 830 stores values representing the numbers of samples when the allowable deviation is less than 4%. The “number of samples when allowable deviation is less than 5%” column 835 stores values representing the numbers of samples when the allowable deviation is less than 5%. The “number of samples when allowable deviation is less than 6%” column 840 stores values representing the numbers of samples when the allowable deviation is less than 6%. The “number of samples when allowable deviation is less than 7%” column 845 stores values representing the numbers of samples when the allowable deviation is less than 7%. The “number of samples when allowable deviation is less than 8%” column 850 stores values representing the numbers of samples when the allowable deviation is less than 8%. The “number of samples when allowable deviation is less than 9%” column 855 stores values representing the numbers of samples when the allowable deviation is less than 9%. Each of values in parentheses in the “number of samples when allowable deviation is less than 2%” column 820 to the “number of samples when allowable deviation is less than 9%” column 855 in FIG. 8 is the number of deviations allowable in the number of samples.

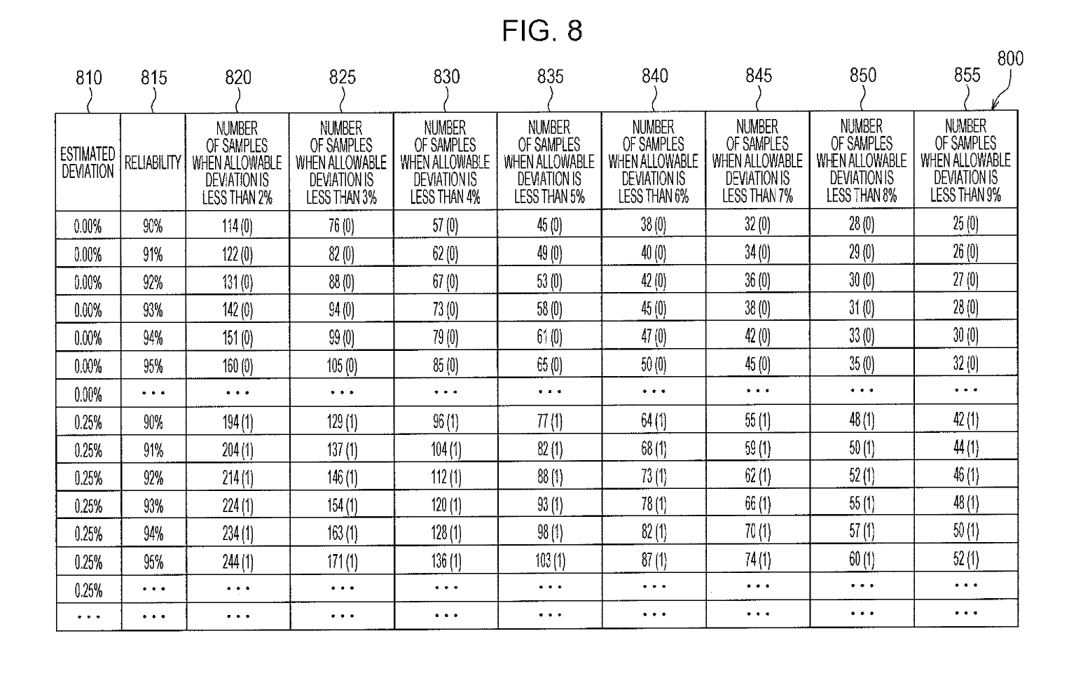

A specific example of processing will be described by using the examples illustrated in FIGS. 9 to 15.

1. The same control (control C01) exists in company X, company Y, and company Z.

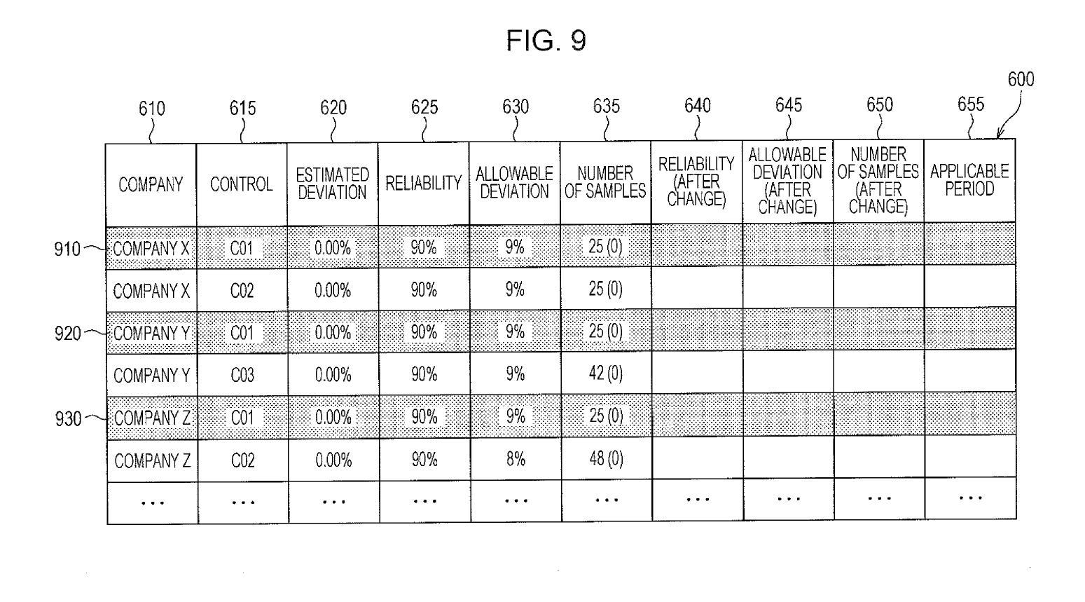

2. The impact of a defect in the control C01 on company X is set to “middle”, the impact of a defect in the control C01 on company Y is set to “large”, and the impact of a defect in the control C01 on company Z is set to “small”. For example, the impacts are set in the manner shown in a control/impact correspondence table 1000. FIG. 10 is an explanatory diagram illustrating an example of the data structure of the control/impact correspondence table 1000. The control/impact correspondence table 1000 includes a “company” column 1010, a “control” column 1020, and an “impact of defect” column 1030. The “company” column 1010 stores unique values specifying individual companies. The “control” column 1020 stores unique values specifying controls in audits of the individual companies. The “impact of defect” column 1030 stores impacts that would be exerted if a defect occurs in the control. Values representing the impacts may be stored, or values representing the above-described “large”, “middle”, and “small” may be stored.

3. An audit method is set as seen in the audit method management table 600 illustrated in FIG. 9, for the same control (control C01) existing in company X, company Y, and company Z (see rows 910, 920, and 930). At this time, the audit method has not been changed, and thus the “reliability (after change)” column 640, the “allowable deviation (after change)” column 645, the “number of samples (after change)” column 650, and the “applicable period” column 655 are blank.

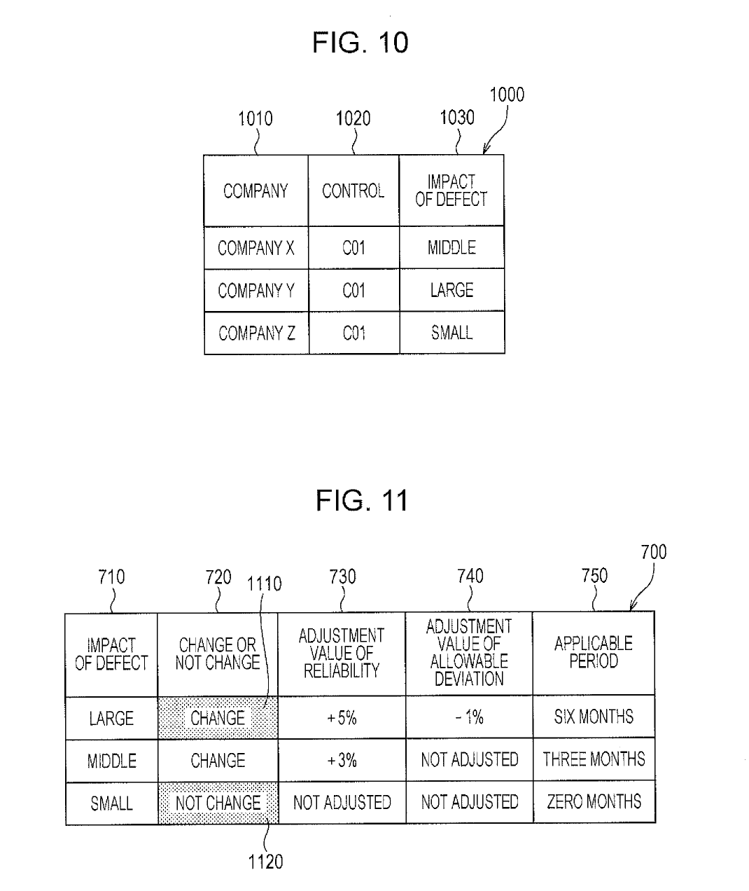

4. In a case where a defect is detected in the control C01 during an audit of company X, it is judged, based on an impact on the control C01 in company Y and company Z, whether or not the audit method needs to be changed. Specifically, since the impact on the control C01 in company Y is “large”, it is judged, by using the change rule management table 700 illustrated in FIG. 11, that the audit method needs to be changed in accordance with a column 1110. Also, since the impact on the control C01 in company Z is “small”, it is judged, by using the change rule management table 700 illustrated in FIG. 11, that the audit method does not need to be changed in accordance with a column 1120.

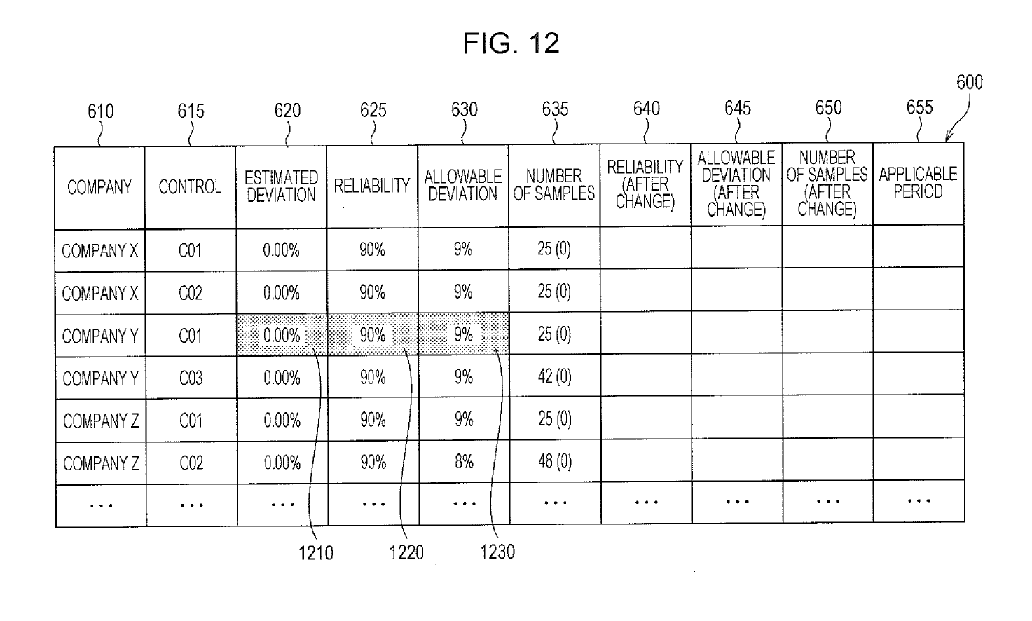

5. A current audit method for the control C01 in company Y, that is, estimated deviation, reliability, and allowable deviation are obtained. Specifically, by using the audit method management table 600 illustrated in FIG. 12, an estimated deviation of 0.00% is obtained from a column 1210, a reliability of 90% is obtained from a column 1220, and an allowable deviation of 9% is obtained from a column 1230.

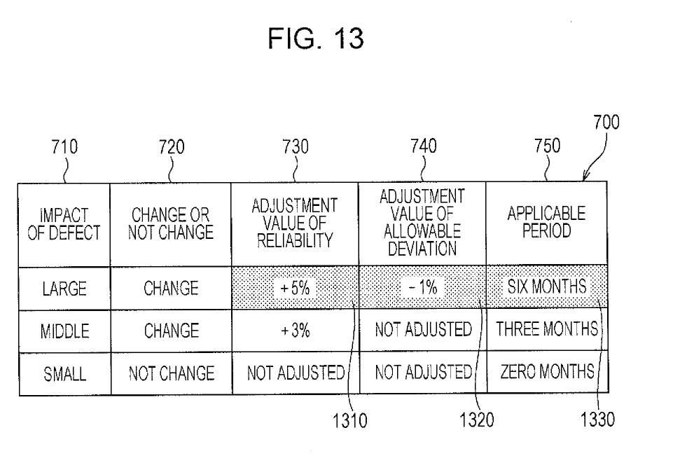

6. An adjustment value of reliability, an adjustment value of allowable deviation, and an applicable period about the impact “large” on the control C01 in company Y are obtained. Specifically, by using the change rule management table 700 illustrated in FIG. 13, an adjustment value of reliability of +5% is obtained from a column 1310, an adjustment value of allowable deviation of −1% is obtained from a column 1320, and an applicable period of six months is obtained from a column 1330.

7. The adjustment values obtained in the process 6 are applied to the reliability of 90% and the allowable deviation of 9% obtained in the process 5, and a reliability of 95% (90+5) and an allowable deviation of 8% (9−1) are calculated as changed values. The estimated deviation is not changed.

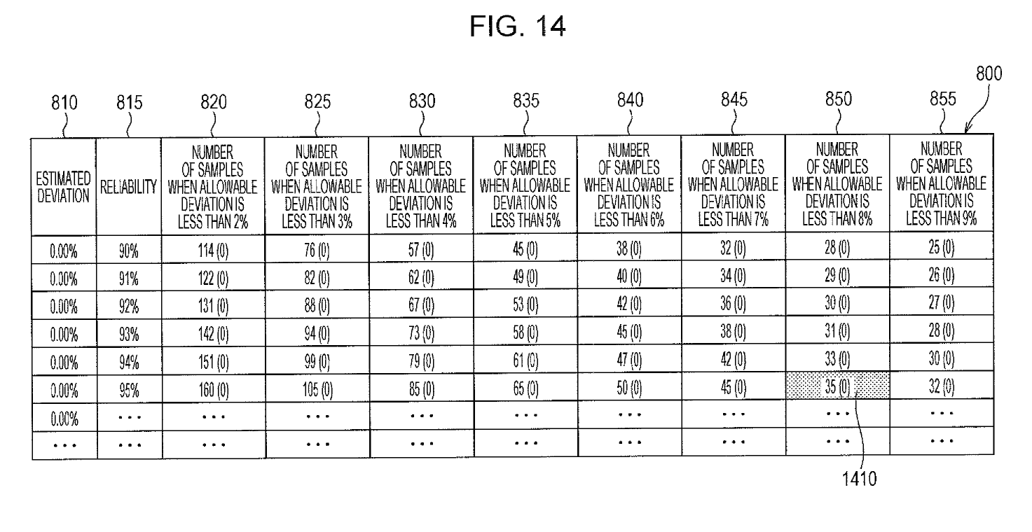

8. By using the estimated deviation obtained in the process 5, and the changed reliability of 95% and the changed allowable deviation of 8% calculated in the process 7, the number of samples after change is obtained by using the number-of-samples management table 800. Specifically, by using the number-of-samples management table 800 illustrated in FIG. 14, “35 (0)” in a column 1410, which is in the “number of samples when allowable deviation is less than 8%” column 850 and which corresponds to an estimated deviation of 0.00% and a reliability of 95%, is obtained.

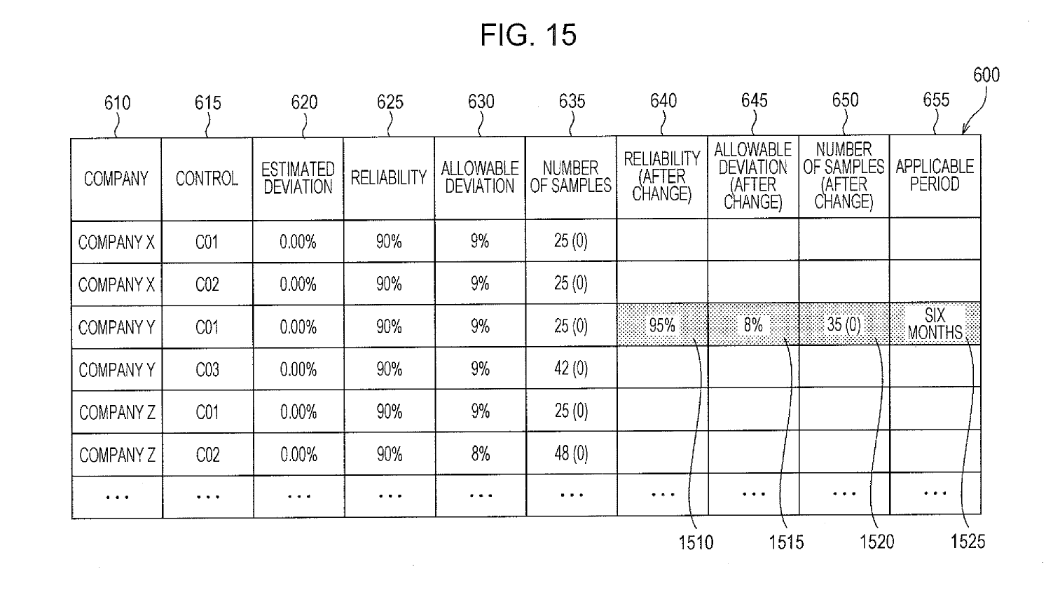

9. The applicable period of six months obtained in the process 6, the changed reliability of 95% and the changed allowable deviation of 8% calculated in the process 7, and the number of samples 35 (0) obtained in the process 8 are set as the values after change of the audit method for the control C01 in company Y. Specifically, a reliability of 95% is set to a column 1510 of the audit method management table 600 illustrated in FIG. 15, an allowable deviation of 8% is set to a column 1515, the number of samples 35 (0) is set to a column 1520, and an applicable period of six months is set to a column 1525.

Accordingly, in a case where a defect occurs in a control during an audit of company X, the audit method for company Y having a control equivalent to (in this example, identical to) the control is changed, as seen in the columns 1510, 1515, 1520, and 1525 in the audit method management table 600 illustrated in FIG. 15.

A description has been given of an example in which all of reliability, allowable deviation, and the number of samples are changed as an audit method. Alternatively, any one of these items or a combination of some of these items may be changed.

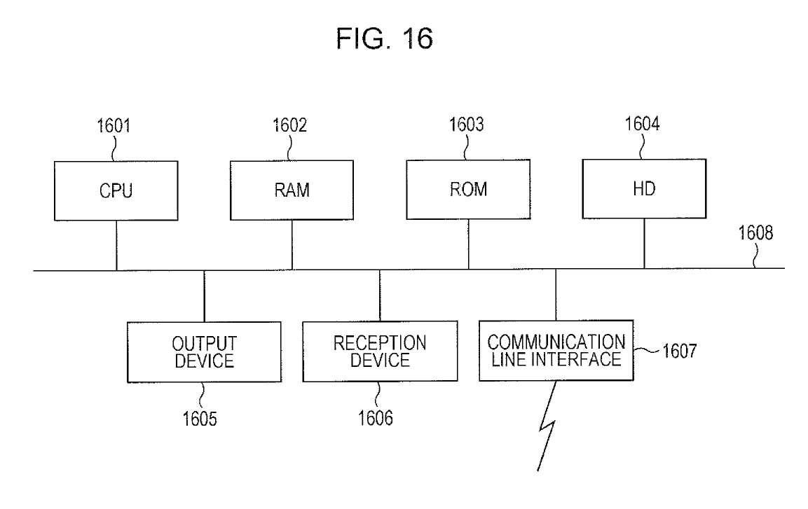

A computer that executes a program according to the exemplary embodiment has a hardware configuration equivalent to that of a typical computer, specifically, a personal computer or a computer that may serve as a server, as illustrated in FIG. 16. That is, as a specific example, a central processing unit (CPU) 1601 is used as a processing unit (computing unit), and a random access memory (RAM) 1602, a read only memory (ROM) 1603, and a hard disk (HD) 1604 are used as storage devices. A hard disk or a solid state drive (SSD) may be used as the HD 1604. The computer is constituted by the CPU 1601 that executes a program implementing the audit method change judgment module 115, the audit method change module 120, the audit method change rule management module 125, the audit execution module 130, the audit result report module 135, the audit method management module 140, the audit schedule management module 145, and so forth; the RAM 1602 storing the program and data; the ROM 1603 storing a program for starting the computer; the HD 1604 serving as an auxiliary storage device (or may be a flash memory or the like); a reception device 1606 that receives data in accordance with an operation performed on a keyboard, mouse, touch panel, or the like by a user; an output device 1605 such as a cathode ray tube (CRT) or a liquid crystal display; a communication line interface 1607 for connecting to a communication network, such as a network interface card; and a bus 1608 for connecting these devices so that data is transmitted and received among these devices. Plural computers, each having the above-described configuration, may be connected to one another via a network.

Among elements of the above-described embodiment, an element based on a computer program is implemented by causing a system having the above-described hardware configuration to read the computer program as software, and causing software resources and hardware resources to cooperate with each other, so that the above-described embodiment is implemented.

The hardware configuration illustrated in FIG. 16 is one example configuration. The hardware configuration according to the exemplary embodiment is not limited to the configuration illustrated in FIG. 16, and any other configurations are applicable as long as the configuration is able to execute the modules described above in the exemplary embodiment. For example, some of the modules may be constituted by dedicated hardware (for example, an application specific integrated circuit (ASIC)). Some of the modules may be provided in an external system and may be connected via a communication line. Further, plural systems each having the configuration illustrated in FIG. 16 may be connected to one another via a communication line so that the systems operate in cooperation with one another. In particular, some of the modules may be incorporated into an information appliance, a copier, a facsimile, a scanner, a printer, or a multifunction peripheral (an image processing apparatus having two or more functions among a scan function, a print function, a copy function, a facsimile function, and so forth), other than a personal computer.

Regarding comparison with a predetermined value in the description of the above-described embodiment, “equal to or more than”, “equal to or less than”, “more than”, and “less than” may be replaced by “more than”, “less than”, “equal to or more than”, and “equal to or less than”, respectively, as long as contradiction does not occur in the combination thereof.

The above-described program may be provided by storing it in a recording medium, or may be provided via a communication medium. In this case, for example, the above-described program may be regarded as “a computer readable recording medium storing a program”.

“The computer readable recording medium storing a program” is a computer readable recording medium storing a program and used for installing, executing, or circulating the program.

Examples of the recording medium include a digital versatile disc (DVD), for example, the standards defined by the DVD forum: DVD-R, DVD-RW, DVD-RAM, and so forth, and the standards defined by DVD+RW: DVD+R, DVD+RW, and so forth; a compact disc (CD), for example, a read only memory (CD-ROM), a CD recordable (CD-R), a CD rewritable (CD-RW), and so forth; a Btu-ray (registered trademark) Disc; a magneto-optical (MO) disc; a flexible disk (FD); a magnetic tape; a hard disk; a read only memory (ROM); an electrically erasable and programmable ROM (EEPROM, registered trademark); a flash memory; a random access memory (RAM); and a secure digital (SD) memory card.

The above-described program or part of the program may be stored or circulated by recording it on the recording medium. Alternatively, the program or part of the program may be transmitted through communication, for example, using a wired network such as a local area network (LAN), a metropolitan area network (MAN), a wide area network (WAN), the Internet, an intranet, or an extranet, or a wireless communication network, or a transmission medium that is obtained by combining the wired and wireless networks. Alternatively, the program or part of the program may be carried using carrier waves.

Further, the above-described program may be part of another program, or may be recorded on a recording medium together with another program. Alternatively, the program may be recorded on plural recording media in a distributed manner. The manner in which the program is recorded is not specified as long as the program is able to be compressed, encrypted, or restored.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a change unit that changes, in a case where a defect of a certain control is detected during an audit of a first organization, an audit method for a second organization that has a control equivalent to the certain control.

2. The information processing apparatus according to claim 1, wherein the change unit changes the audit method for the second organization in a case where an impact that would affect the second organization if a defect occurs in the equivalent control of the second organization is larger than or equal to a predetermined threshold.

3. The information processing apparatus according to claim 1, wherein the change unit determines a period over which a changed audit method for the second organization is applicable, stores an original audit method before change, and changes the changed audit method to the stored original audit method after the period has elapsed.

4. The information processing apparatus according to claim 2, wherein the change unit determines a period over which a changed audit method for the second organization is applicable, stores an original audit method before change, and changes the changed audit method to the stored original audit method after the period has elapsed.

5. The information processing apparatus according to claim 1, wherein the change unit changes, as an audit method, any one of reliability, allowable deviation, and the number of samples, or a combination of some or all of the reliability, the allowable deviation, and the number of samples.

6. The information processing apparatus according to claim 2, wherein the change unit changes, as an audit method, any one of reliability, allowable deviation, and the number of samples, or a combination of some or all of the reliability, the allowable deviation, and the number of samples.

7. The information processing apparatus according to claim 3, wherein the change unit changes, as an audit method, any one of reliability, allowable deviation, and the number of samples, or a combination of some or all of the reliability, the allowable deviation, and the number of samples.

8. The information processing apparatus according to claim 4, wherein the change unit changes, as an audit method, any one of reliability, allowable deviation, and the number of samples, or a combination of some or all of the reliability, the allowable deviation, and the number of samples.

9. An information processing method comprising:
changing, in a case where a defect of a certain control is detected during an audit of a first organization, an audit method for a second organization that has a control equivalent to the certain control.

10. A non-transitory computer readable medium storing a program causing a computer to execute a process for information processing, the process comprising:
changing, in a case where a defect of a certain control is detected during an audit of a first organization, an audit method for a second organization that has a control equivalent to the certain control.
